(19) United States
(12) Patent Application Publication
(10) Pub. No.: US 2015/0090333 A1
(43) Pub. Date: Apr. 2, 2015

(54) ELECTROLYTE-SEALING STRUCTURE AND MANUFACTURING METHOD THEREOF

(71) Applicant: TAIYO YUDEN CO., LTD., Tokyo (JP)

(72) Inventor: Hidenori SOMEI, Takasaki-shi (JP)

(21) Appl. No.: 14/498,574

(22) Filed: Sep. 26, 2014

(30) Foreign Application Priority Data
Sep. 30, 2013 (JP) 2013205371

(51) Int. Cl. H01G 9/20

(52) U.S. Cl. CPC H01G 9/2077
USPC 136/256; 438/64

(57) ABSTRACT

An electrolyte-sealing structure for a dye-sensitized solar cell includes: a pair of opposing substrates; a fluid electrolyte sealed between the substrates; a thermoplastic resin layer positioned in such a way as to laminate the pair of substrates together while providing an area in which the fluid electrolyte is to be sealed; and a siloxane-containing layer between each of the substrates and the thermoplastic resin.

### FIELD OF THE INVENTION

The present invention relates to an electrolyte-sealing structure for a dye-sensitized solar cell (hereinafter also referred to as “DSSC”) and manufacturing method thereof.

### DESCRIPTION OF THE RELATED ART

A DSSC is structured in such a way that a powered generation electrode (negative electrode) on which a metal oxide layer supporting a sensitizing dye is formed faces an opposing electrode (positive electrode) on which a catalyst layer is formed, with the opposing electrodes holding an electrolytic solution containing electrolyte in between. When light is irradiated onto a DSSC, the dye adsorbed onto the titanium oxide constituting the metal oxide layer undergoes electron excitation and the excited electrons are injected into a titanium oxide conductor so that the electrons migrate from the titanium oxide to an ITO- or FTO-based transparent conductive film to be taken out as electrical current. This process requires a sealing structure to seal the electrolytic solution between the two electrodes.

For example, Patent Literature 1 discloses a sealing material that contains a thermoplastic elastomer primarily constituted by a copolymer of styrene and diene hydrocarbons, and suggests such possibilities as kneading and mixing said elastomer under heat with a filler, acrylic oligomer, and silane coupling agent, as necessary, or dispersing them together in a solvent, and then applying the mixture/dispersant.

### BACKGROUND ART LITERATURES

[Patent Literature 1] Japanese Patent Laid-open No. 2005-306946

### SUMMARY

There has been a demand in recent years for DSSCs with a sealing structure offering stronger bonding and higher sealing performance. In light of such demand, the present invention aims to provide a new sealing structure that can improve the sealant bonding and sealing performance of a DSSC, as well as a manufacturing method of said sealing structure.

Any discussion of problems and solutions involved in the related art has been included in this disclosure solely for the purposes of providing a context for the present invention, and should not be taken as an admission that any or all of the discussion were known at the time the invention was made.

After studying in earnest, the inventors of the present invention completed the invention described below.

The sealing structure proposed by the present invention has a pair of substrates (basal plate) opposing each other. Sealed between this pair of substrates is a fluid electrolyte. This pair of substrates is laminated together via a thermoplastic resin layer, while providing an area in which the fluid electrolyte is to be sealed. A siloxane-containing layer is present between each of the substrates and the thermoplastic resin layer.

Preferably at least one of the pair of substrates is constituted by a glass or plastic sheet with a transparent electrode and power generation layer laminated on top in this order.

According to the manufacturing method proposed by the present invention, first a siloxane-containing layer is formed on each bonding surface of a pair of substrates by, applying a silane coupling agent to each bonding surface, after which the silane coupling agent is dried or the like. Then, a thermoplastic resin layer is formed on top of the siloxane-containing layer(s) on the bonding surface(s) of both or one of this pair of substrates. At this time, the thermoplastic resin layer is applied in a shape such that an area in which the fluid electrolyte can be sealed is provided. Next, the pair of substrates is laminated together with their bonding surfaces facing each other. The fluid electrolyte is then sealed in the area that has been provided between the pair of substrates as described above. The fluid electrolyte may be supplied before or after the pair of substrates are laminated together.

According to the present invention, flexible substrates such as plastic substrates can be supported because the use, as the sealing resin, of a thermoplastic resin that generally has low hardness mitigates stress. In addition, since the thermoplastic resin the present invention uses does not require any UV curing agent, there will be no elution of UV curing agent or its reaction residue into the electrolytic solution, and therefore a stable solar cell element can be obtained. By giving silane-coupling treatment to the surface of an ITO- or FTO-based transparent conductive film, strong bonds can be formed between the treated surface and the polar substitution groups contained in the resin, which in turn suppress leakage of electrolytic solution and also allow the electrode substrates to bond together strongly.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a schematic cross section view of a sealing structure conforming to the present invention.

[Description of the Symbols]

| | |
|---|---|
| 11: | Transparent substrate |
| 12: | Transparent electrode |
| 13: | Electrode substrate |
| 14: | Catalyst layer |
| 15: | Power generation layer |
| 21: | Thermoplastic resin layer |
| 22, 23: | Siloxane-containing layer |
| 31: | Fluid electrolyte |

### DETAILED DESCRIPTION OF EMBODIMENTS

The present invention is described in detail by referring to the drawing as deemed appropriate. It should be noted, however, that the present invention is not limited to the embodiment illustrated herein and that, because characteristic parts of the invention may be emphasized in the drawing, the scale is not necessarily accurate in each part of the drawing.

According to the present invention, a fluid-electrolyte-sealing structure for a DSSC is provided. In general, a DSSC is used together with some type of medium. An electrolyte which is fluid, or mixed with a medium that can fluidize the electrolyte, is called “fluid electrolyte.” Fluidizing patterns include, but are not limited to, liquefaction (electrolytic solution) and gelling, for example. Specific embodiments of fluid electrolyte may be achieved by applying the prior art pertaining to DSSCs as deemed necessary, where some specific examples are covered by the examples described later.

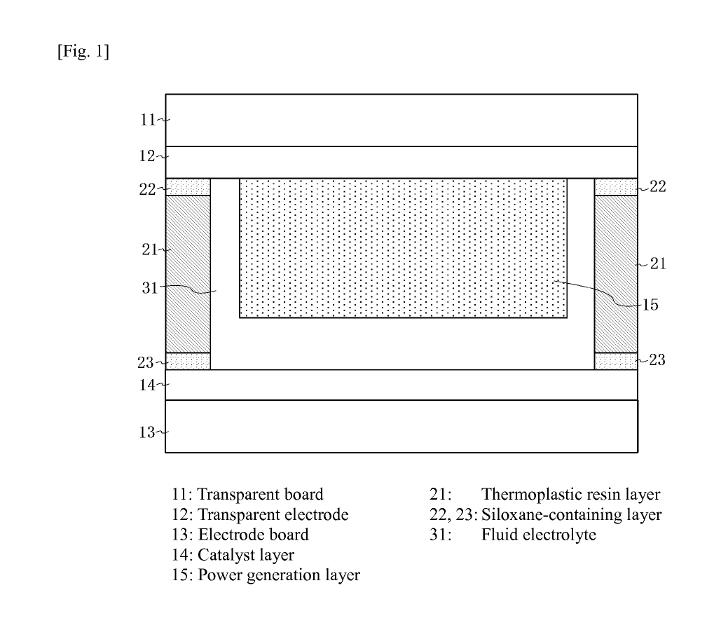

FIG. 1 is a schematic cross section view (taken along a longitudinal direction) of a sealing structure conforming to the present invention (in some embodiment, a schematic cross section view taken along a direction perpendicular to the longitudinal direction is basically the same as the view in FIG. 1). The sealing structure conforming to the present invention has a pair of opposing substrates. Substrates of any type or material may be used so long as they are sheet-shaped and prevent permeation of fluid electrolyte. In the embodiment shown in FIG. 1, one substrate consists of a laminate comprising a transparent substrate 11, transparent electrode 12 and power generation layer 15, while the other opposing substrate consists of an electrode substrate 13 on which a catalyst layer 14 is formed. As illustrated, one or both of the pair of substrates may be a laminate comprising multiple layers and films. The substrates may be hard substrates or substrates having flexibility (so-called “flexible substrates”).

Preferably at least one of the pair of substrates is constituted by a glass or plastic sheet with a transparent electrode and power generation layer laminated on top in this order. This preferable mode is shown in FIG. 1. The transparent substrate 11 may use glass or plastics, but its material is not limited to the foregoing. The transparent electrode 12 may be in the form of ITO or FTO, but its form is not limited to the foregoing. The power generation layer 15 preferably provided adjacent to the transparent electrode 12 may be a porous film constituted by titanium oxide or zinc oxide, but its composition is not limited to the foregoing.

Preferably the other opposing substrate consists of a laminate comprising an electrode substrate 13 and catalyst layer 14. Preferably the electrode substrate 13 is a glass or plastic sheet having a metal film (electrode film) formed on top, and the catalyst layer 14 on top of the metal film is preferably constituted by a thin platinum film, conductive polymer, or carbon.

The pair of boards is bonded together via a thermoplastic resin which constitutes a thermoplastic resin layer 21 between the boards. The thermoplastic resin used under the present invention is a resin that softens and exhibits plasticity when heated, and solidifies when cooled, where a polymer that need not be cured with UV light and has a side chain of acid or alkali functional groups is used favorably. The basic skeleton of the thermoplastic resin is not limited in any way, but preferable choices include, but not limited to, polyolefin skeleton, polyoxy alkylene skeleton, cellulose skeleton, polyimide skeleton, and the like. Preferable choices of functional groups being held as a side chain include, but not limited to, carboxyl groups, carboxylate residue, and the like. Specific resins include, but not limited to, ionomer resin, polyethylene glycol copolymer, methyl cellulose copolymer, ethyl cellulose copolymer, vinylidene polyfluoride copolymer, polymethyl methacrylate copolymer, polyacrylonitrile copolymer, polyolefin copolymer, saponified methyl cellulose, saponified ethyl cellulose, modified vinylidene polyfluoride, saponified polymethyl methacrylate, saponified polyacrylonitrile, modified polyolefin, modified polyimide, modified polyolefin copolymer, modified polyimide copolymer, modified polyamide imide, modified polytetrafluoroethylene, saponified polyvinyl alcohol, saponified polyvinyl butyrate, and the like.

The thermoplastic resin layer 21 is provided in a manner laminating the aforementioned pair of substrates 11 to 15 together. To be specific, it is generally provided between one substrate 11, 12, 15 and the other substrate 13, 14. The thermoplastic resin layer 21 is provided at a position where an area in which the fluid electrolyte 31 is to be sealed can be provided, but it can also be positioned inside the area to seal the fluid electrolyte 31 in, so as to ensure laminating strength. Specific examples include forming the thermoplastic resin layer 21 in a shape that delineates an area in which the fluid electrolyte 31 is to be sealed.

Many conventional sealants for dye-sensitized solar cells use materials that harden when cured, thus causing the bonded substrates to often separate from each other at their interface when stress is applied. According to the present invention, polar substitution groups are introduced by softening the resin, copolymerizing it with a monomer having polar substitution groups, or modifying the resin, so that a dye-sensitized solar cell can be provided, offering stronger bonding to the surface of an ITO- or FTO-based transparent conductive film, as well as improved reliability.

According to the present invention, a siloxane-containing layer 22, 23 is provided between the substrate and the thermoplastic resin layer. Siloxane is a substance whose skeleton consists of silicon and oxygen, and has Si—O—Si bond (siloxane bond). Preferably the siloxane-containing layer 22, 23 is a layer constituted by a compound, including a simple siloxane compound or organic polysiloxane being a polymer comprising a long chain of siloxane bonds, where a silicon atom is bonded to one to three organic group(s). Since the siloxane bond causes the hydrogen bond to occur, the bonding property with the substrates 11 to 15 is expected to improve, while improved affinity is expected between the organic group(s) bonded to the silicon atom and the aforementioned thermoplastic resin layer 21. This is expected to improve the bonding force between the thermoplastic resin being the sealing resin on one hand and the substrate on the other, thereby improving the sealing ability with respect to the fluid electrolyte 31. The siloxane-containing layer is a discreate layer and does not constitute a part of the thermoplastic resin layer, i.e., the siloxane-containing layer and the thermoplastic resin layer are mutually exclusive in some embodiments.

The method for forming the siloxane-containing layer 22, 23 is not limited in any way, but preferably it is formed by applying and drying a silane-coupling agent. When a silane-coupling agent is diluted by alcohol or solvent produced by mixing alcohol and water, and then the diluted silane-coupling agent is applied to the surfaces of the substrates 11 to 15 to be laminated (hereinafter referred to as “bonding surfaces”) and dried in air, hydrolytic reaction and dehydration condensation reaction are promoted in the silane-coupling agent to produce the aforementioned siloxane bond, and consequently a siloxane-containing layer is formed. At this time, the area of the transparent electrode 12 adjacent to the transparent substrate 11 may be smaller than that of the transparent substrate 11, and the applied siloxane-containing layer 22, 23 may be contacting the transparent substrate 11. Similarly, the area of the catalyst layer 14 adjacent to the electrode substrate 13 may be smaller than that of the electrode substrate 13, and the applied siloxane-containing layer 22, 23 may be contacting the electrode substrate 13. Presence of the siloxane-containing layer 22, 23 can be detected by an SEM (scanning electron microscope) image or chemical analysis of its section, for example. Preferably the silane-coupling agent used here contains alkyl amine or epoxy groups. Presence of a siloxane-containing layer derived from a silane-coupling agent achieves strong bonding and high fluid-electrolyte-sealing property at the same time.

For this reason, according to the manufacturing method proposed by the present invention a process is provided whereby a silane-coupling agent is applied to the bonding surfaces of the substrates 11 to 15 and then dried, after which a thermoplastic resin is applied on top of the siloxane-containing layer 22, 23 produced as a result of drying. At this time, the thermoplastic resin is applied in a shape that provides an area in which the fluid electrolyte is to be sealed. When this is done, the area of the location where the thermoplastic resin is applied may be exactly the same as the area of the part where the siloxane-containing layer 22, 23 has been applied, or it may be larger or smaller than the area of the part where the siloxane-containing layer 22, 23 has been applied. As long as the substrates 11 to 15 can finally be laminated, the thermoplastic resin may be applied to both of the pair of substrates or only one of the substrates. After the thermoplastic resin has been applied, the substrates 11 to 15 are bonded together with their bonding surfaces facing each other, and then the thermoplastic resin is dried to form a thermoplastic resin layer 21. The fluid electrolyte 31 can be introduced between any of the aforementioned processes or at the last process before sealing.

Under the manufacturing method proposed by the present invention, any conventional technology may be applied as deemed appropriate for the method to apply/dry the silane-coupling agent or thermoplastic resin, the method to laminate the boards and fill the fluid electrolyte, and the like, and accordingly those skilled in the art can provide a DSSC having a sealing structure of excellent sealing performance in view of the present disclosure, as a matter of routine experimentation.

### EXAMPLES

The present invention is explained specifically below using examples. It should be noted, however, that the present invention is not limited to the embodiments described in these examples.

### Example 1

### Bonding the ITO Surface of a Plastic/ITO Substrate and the Surface of a Titanium Substrate

KBE-903 by Shin-Etsu Silicone was used as a general silane-coupling agent. A mixture solution consisting of 9 parts ethanol and 1 part water was used to dilute this silane-coupling agent tenfold (unless otherwise specified, the same weight ratio applies hereinafter). The above diluted silane-coupling agent was applied as the sealing resin to the intended sealing area on the ITO surface of a substrate comprising a plastic sheet with an ITO film formed on top (plastic/ITO substrate), and then dried at room temperature for approximately 30 minutes. Separately, a sheet-shaped titanium electrode on which a catalyst layer was formed was prepared, and the above diluted silane-coupling agent was also applied to the intended sealing area on its surface and then dried at room temperature for approximately 30 minutes. Maleic anhydride-modified polypropylene/1-butene copolymer resin, which is a thermoplastic resin, was applied to both the ITO surface of the plastic/ITO substrate and the surface of the titanium electrode, which had been coated with the silane-coupling agent, and then dried at room temperature for approx. 1 hour. Thereafter, the sealing resin-coated parts were arranged to face each other. For the electrolytic solution, an acetonitrile solution with 0.6 M of iodized 1,2-dimethyl-3-propyl imidazolium, 0.1 M of iodized lithium, 0.05 M of iodine, and 0.5 M of t-butyl pyridine was prepared. Using a syringe, this electrolytic solution was injected into the space on the inner side of the sealing resin-coated locations. Thereafter, the sealed parts were pressure-bonded together under heat to seal the electrolytic solution between the two electrodes.

The cell thus produced was heated to 85° C., with the sealed parts measured for damage and weight change before and after the heating. Since acetonitrile used as the solvent for the electrolytic solution is highly volatile, heating to 85° C. may cause the cell to swell and the weak areas of the sealed parts to be damaged. If the sealed parts are found damaged, volatilized electrolytic solution must have leaked out from the damaged part to cause weight loss. In reality, however, the sealed parts presented no visible damage after the heating. Also, only less than 0.1% of weight was lost after the heating as compared to before the heating.

### Example 2

### Bonding the ITO Surface of a Plastic/ITO Substrate and the Surface of a Titanium Substrate

A cell was produced under the same conditions as in Example 1, except that polyamide imide resin, which is a thermoplastic resin, was used as the sealing resin, and the cell was evaluated after heating to 85° C. The sealed parts presented no visible damage after the heating. Also, only less than 0.1% of weight was lost after the heating as compared to before the heating.

### Example 3

### Bonding the ITO Surface of a Plastic/ITO Substrate and the Surface of a Titanium Substrate

A cell was produced under the same conditions as in Example 1, except that siloxane-modified polyimide resin, which is a thermoplastic resin, was used as the thermoplastic sealant, and the cell was evaluated after heating to 85° C. The sealed parts presented no visible damage after the heating. Also, only less than 0.1% of weight was lost after the heating as compared to before the heating.

### Example 4

### Bonding the ITO Surface of a Plastic/ITO Substrate and the Surface of a Titanium Substrate

A cell was produced under the same conditions as in Example 1, except that ionomer resin having a polyethylene skeleton and a side chain comprising methacylate residue (Himilan) was used as the thermoplastic sealant, and the cell was evaluated after heating to 85° C. The sealed parts presented no visible damage after the heating. Also, only less than 0.3% of weight was lost after the heating as compared to before the heating.

### Example 5

### Manufacturing a Dye-Sensitized Solar Cell (DSSC)

KBE-903 by Shin-Etsu Silicone was used as a general silane-coupling agent. A mixture solution consisting of 9 parts ethanol and 1 part water was used to dilute this silane-coupling agent fivefold. The above diluted silane-coupling agent was applied to the intended sealing area on the ITO surface of a DSSC substrate comprising a plastic sheet with an ITO film formed on top (plastic/ITO substrate), and then dried at room temperature for approximately 30 minutes. Separately, an electrode comprising a titanium sheet with a platinum film formed on top by means of sputtering (titanium/platinum electrode) was prepared, and the above diluted silane-coupling agent was also applied to the intended sealing area on its platinum surface and then dried at room temperature for approximately 30 minutes. Maleic anhydride-modified polypropylene/1-butene copolymer resin, which is a thermoplastic resin, was applied as the sealing resin to both the ITO surface of the plastic/ITO substrate and platinum surface of the titanium/platinum electrode, which had been coated with the silane-coupling agent, and then dried at room temperature for approximately 1 hour. Thereafter, the sealing resin-coated parts were arranged to face each other. For the electrolytic solution, a propylene carbonate/ethylene carbonate solution with 0.6 M of iodized 1,2-dimethyl-3-propyl imidazolium, 0.1 M of iodized lithium, 0.05 M of iodine, and 0.5 M of t-butyl pyridine was prepared. Using a dropper, this electrolytic solution was injected into the space on the inner side of the sealing resin-coated locations. Thereafter, the sealed parts were pressure-bonded together under heat to seal the electrolytic solution between the two electrodes. This way, a DSSC was obtained.

The obtained DSSC is yet to produce any damage to the sealed parts after having been kept for two years at room temperature.

When sections of the products manufactured in Examples 1 to 5 were observed with an SEM, the siloxane-containing layer 22, 23, and a different layer corresponding to the thermoplastic resin layer 21, were detected between the pair of bonded substrates. When the layer 22, 23 positioned between the substrate and thermoplastic resin layer 21 was chemically analyzed using an energy-dispersive X-ray spectrometer (EDS, EDX), presence of Si—O—Si bond was confirmed, which in turn confirmed this layer as a siloxane-containing layer.

### Comparative Example 1

### Using a UV Curing Resin

A DSSC was produced under the same conditions as in Example 5, except that epoxy-based UV curing resin was used as the sealing resin, and when the DSSC was kept at room temperature and observed continuously, the electrolytic solution began leaking everywhere from the sealed parts in about one week, revealing the lack of adhesion force of the sealant with respect to the plastic substrate. It was also revealed that the dye in the titanium oxide film would dissociate as a result of elution of unreacted monomer and initiator into the electrolytic solution.

### Comparative Example 2

### Bonding the ITO Surface of a Plastic/ITO Substrate and the Surface of a Titanium Substrate

A cell was produced under the same conditions as in Example 1, except that no silane-coupling treatment was given, and the cell was evaluated after heating to 85° C. After the heating, the sealed parts presented much damage that was clearly visible. Also, 6% of weight was lost after the heating as compared to before the heating, which is a clear indication that the electrolytic solution was leaking

### Comparative Example 3

### Manufacturing a DSSC

A DSSC was produced under the same conditions as in Example 5, except that no silane-coupling treatment was given, and when the DSSC was kept at room temperature and observed continuously, the electrolytic solution began leaking from the sealed parts in about five days, confirming that air bubbles were entering between the electrodes. This shows that use of maleic anhydride-modified polypropylene 1-butene copolymer or other thermoplastic resin alone does not achieve sufficient sealing performance.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, an article “a” or “an” may refer to a species or a genus including multiple species, and “the invention” or “the present invention” may refer to at least one of the embodiments or aspects explicitly, necessarily, or inherently disclosed herein. The terms “constituted by” and “having” refer independently to “typically or broadly comprising”, “comprising”, “consisting essentially of”, or “consisting of” in some embodiments. In this disclosure, any defined meanings do not necessarily exclude ordinary and customary meanings in some embodiments.

The present application claims priority to Japanese Patent Application No. 2013-205371, filed Sep. 30, 2013, the disclosure of which is incorporated herein by reference in its entirety, for some embodiments.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. An electrolyte-sealing structure for a dye-sensitized solar cell, having:
a pair of opposing substrates;
a fluid electrolyte sealed between the substrates;
a thermoplastic resin layer disposed to laminate the pair of substrates together while providing an area in which the fluid electrolyte is sealed; and
a siloxane-containing layer disposed between each of the substrates and the thermoplastic resin layer.

2. An electrolyte-sealing structure according to claim 1, wherein at least one of the pair of substrates is constituted by a glass or plastic sheet with a transparent electrode and a power generation layer laminated on top in this order.

3. An electrolyte-sealing structure according to claim 1, wherein the siloxane-containing layer is constituted by a silane-coupling agent.

4. A manufacturing method of electrolyte-sealing structure for a dye-sensitized solar cell, comprising:
forming a siloxane-containing layer on bonding surfaces of a pair of substrates having the respective bonding surfaces;
forming a thermoplastic resin layer, in a manner providing an area in which fluid electrolyte is to be sealed, on top of the siloxane-containing layer formed on the bonding surface of at least one of the substrates;
laminating the pair of substrates together with their bonding surfaces facing each other; and
introducing fluid electrolyte between the pair of substrates before or after the substrates are laminated, followed by sealing the fluid electrolyte.
